(19) United States
(12) Patent Application Publication
(10) Pub. No.: US 2024/0234876 A1
(43) Pub. Date: Jul. 11, 2024

(54) DEVICE FOR ELECTRICALLY CONNECTING A FUEL CELL STACK AND A HIGH-VOLTAGE BATTERY

(71) Applicant: CELLCENTRIC GMBH & CO. KG, Kirchheim/Teck-Nabern (DE)

(72) Inventors: Oliver HARR, Kirchheim/Teck-Nabern (DE); Philipp HAUSMANN, Kirchheim/Teck-Nabern (DE); BENJAMIN PIECK, Kirchheim/Teck-Nabern (DE); Florian BIESINGER, Kirchheim/Teck-Nabern (DE)

(21) Appl. No.: 18/559,457

(22) PCT Filed: Jun. 8, 2022
(86) PCT No.: PCT/EP2022/065537

§ 371 Date: Nov. 7, 2023

(30) Foreign Application Priority Data
Jun. 9, 2021 (DE) 10 2021 205 802.7

(51) Int. Cl. H01M 16/00; H01M 8/04537

(52) U.S. Cl. CPC H01M 16/006; H01M 8/04559; H01M 2200/00

(57) ABSTRACT

The invention relates to a device for electrically connecting at least one fuel cell stack and at least one high-voltage battery for supplying electrical energy to consumers which are connected on the side of the high-voltage-battery.

The invention is characterized in that the fuel cell stack and the high-voltage battery are connected to one another via at least one diode, which blocks current flow in the direction of the fuel cell stack, and at least one switch for closing and breaking the connection.

According to the method, the switch is controlled depending on the voltages of firstly the at least one fuel cell stack and secondly the at least one high-voltage battery.

The invention relates to a device for electrically connecting at least one fuel cell stack and at least one high-voltage battery in a fuel cell system of the type according to the preamble of claim 1. The invention also relates to a method for operating such a device.

The distribution of energy in a fuel cell system usually takes place via a so-called fuel cell interface, which has at least one direct current converter or DC/DC converter. These interfaces are often located in the area of the fuel cell or its housing itself. In principle, such a structure is known from DE 100 06 781 A1. In this context, reference can also be made to US 2015/0295401 A1.

DE 10 2018 213 159 A1 describes an electrical energy system with such a fuel cell interface that is optimized in terms of safety. An emergency shutdown for the battery is implemented via a battery safety switch arranged after a DC converter and thus between this and a battery. The fuel cell itself is arranged on the opposite side of the DC converter and in turn has an emergency discharge device.

The object of the present invention is to further simplify this structure of a fuel cell interface or FCI, which is basically known from the prior art.

According to the invention, this object is achieved by a device with the features of claim 1, and in particular of the characterizing part of claim 1. Advantageous designs and developments of the device result from the claims dependent thereon.

When connecting the high-voltage battery and the fuel cell stack, the device according to the invention dispenses with the usual DC/DC converter described in the prior art as a step-up converter/step-down converter. A simple fuel cell power interface can be implemented via at least one diode which blocks current flow from the high-voltage battery to the fuel cell stack and via at least one switch, in particular a contactor, for connecting the high-voltage battery and the fuel cell stack The device or fuel cell power interface according to the invention achieves the above-mentioned object in a very cost-effective manner, in which neither a converter nor a precharging circuit are required. By eliminating the converter, there are no current ripples affecting the fuel cell stack, which cannot be avoided when using a converter. However, since these put enormous strain on the fuel cell stack, the elimination of the DC/DC converter also increases the service life of the fuel cell stack. Furthermore, by dispensing with the converter, its relatively poor efficiency on the power distribution can be obtained. The overall efficiency can thus be increased.

The very simple connection of the device according to the invention enables, in addition to increasing the efficiency and service life of the fuel cell stack, a weight reduction compared to current concepts and implementations and a clear interface, which causes less effort when adapting the fuel cell stack. Furthermore, a saving of installation space and cost savings can be achieved by eliminating the DC/DC converter.

The invention thus enables enormous competitive advantages both in terms of reducing weight, costs and installation space as well as in terms of increasing the efficiency and service life of a fuel cell system with such a fuel cell power interface according to the invention. A very advantageous development of the invention accordingly provides for the connection to be carried out without a converter.

The device according to the invention is suitable for both truck applications and stationary fuel cell systems. Particularly when used in a mobile system, such as a truck, according to a very advantageous development, it can now be provided that an emergency shutdown device is provided for the at least one fuel cell stack. In the case, for example, by means of such an emergency shutdown device, the fuel cell stack can be disconnected from the high-voltage battery and preferably short-circuited it so that it no longer poses any danger.

According to a very advantageous development, the emergency shutdown device in the device according to the invention can be designed as or include a pyrotechnic closer and can be connected to an external communication interface. Such a pyrotechnic closer can be connected, for example, to crash sensors of a vehicle equipped with the device.

In the event of an accident, for example in the event that an airbag is triggered or the like, a signal can then be simultaneously sent via this sensor system to the device according to the invention in the advantageous development described in order to trigger the pyrotechnic closer and connect the poles of the fuel cell stack, so short-circuiting it.

A further very advantageous embodiment of the device according to the invention provides that a control of the switch is connected to an external communication interface, wherein the switch is designed in particular as a line switch or contactor. This connection can in particular be different than that of the pyrotechnic closer in the embodiment described above. The switch is implemented as a battery safety switch, which is typically designed as a contactor in order to connect and disconnect both poles of the electrical connection depending on a control signal on the external communication interface.

A particularly favorable embodiment of the device according to the invention provides devices for detecting the voltage of the fuel cell stack and the high-voltage battery. These, which are arranged on the side of the switch facing the fuel cell stack or the high-voltage battery, can be used to detect the voltage of the fuel cell stack and the high-voltage battery independently of one another when the switch is open. Furthermore, an ammeter can be part of the device.

In this structure, according to a very advantageous development thereof, it can now be provided that the control of the switch or an external control connected to the communication interface is set up to actuate the switch depending on the voltages detected via the devices for detecting the voltage of the fuel cell stack and the high-voltage battery. The voltages ultimately serve to control the switch, which also makes control simple and efficient.

A further very favorable embodiment of the device according to the invention now also provides that at least one electrical connection, secured via fuses, for auxiliary units of the fuel cell system, for example conveying devices for air, hydrogen recirculation blowers and the like, are provided between the diode and the battery connection, so that via the device also these components can be supplied directly with power and protected with fuses located in the device. According to an advantageous embodiment, the consumers themselves can then be connected via the battery connections or in parallel to the high-voltage battery in order to keep the structure simple and compact.

The entire device can be integrated in particular into a common housing, which is designed for mounting on the fuel cell, namely the fuel cell stack. The fuel cell power interface is therefore integrated into the structure of the fuel cell stack, in particular in or on its housing, in order to correspondingly reduce the cabling effort and to realize a single efficient interface module with the device according to the invention.

The method according to the invention now serves to operate such a device in one or the other of the embodiments described above. According to the method, it is provided that the switch is controlled depending on the voltages of the at least one fuel cell stack on the one hand and the at least one high-voltage battery on the other hand. These voltages, which are typically measured anyway, enable very simple and efficient implementation of the control.

According to a very favorable embodiment of the method, it can be provided that the switch is closed before the voltage of the fuel cell stack reaches the voltage of the high-voltage battery. The diode prevents current from flowing in the direction of the fuel cell stack. As the voltage on the fuel cell stack increases, a current then begins to flow to the high-voltage battery or to the consumer. There is no need to precharge the high-voltage intermediate circuit because the diode protects the fuel cell stack. The simple connection of the device according to the invention leads to a simple, self-regulated system.

Further advantageous embodiments of the device according to the invention and of the method for its operation result from the exemplary embodiments which is described in more detail hereinafter with reference to the figures.

In particular:

FIG. 1 shows a possible structure of the device according to the invention;

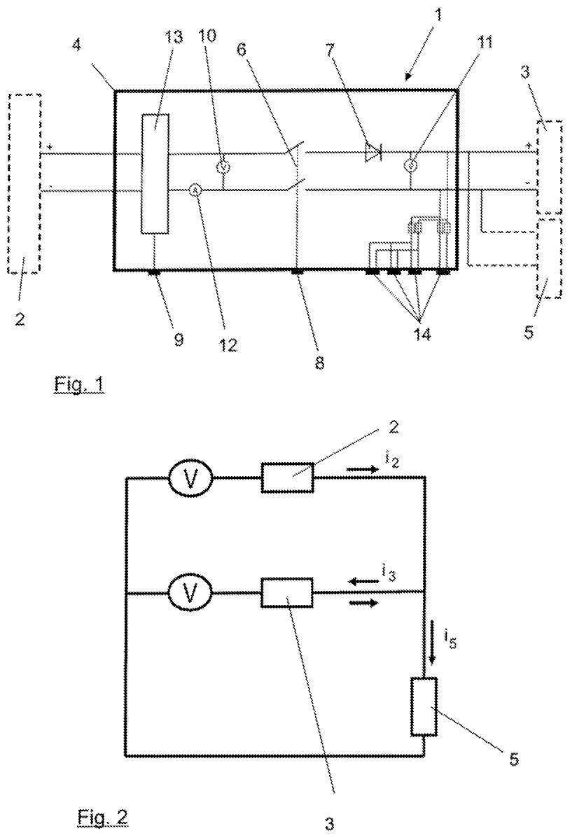

FIG. 2 shows a very simplified representation of the current flows in an assumed structure;

FIG. 3 shows one the profile of the pole curve of the assumed structure;

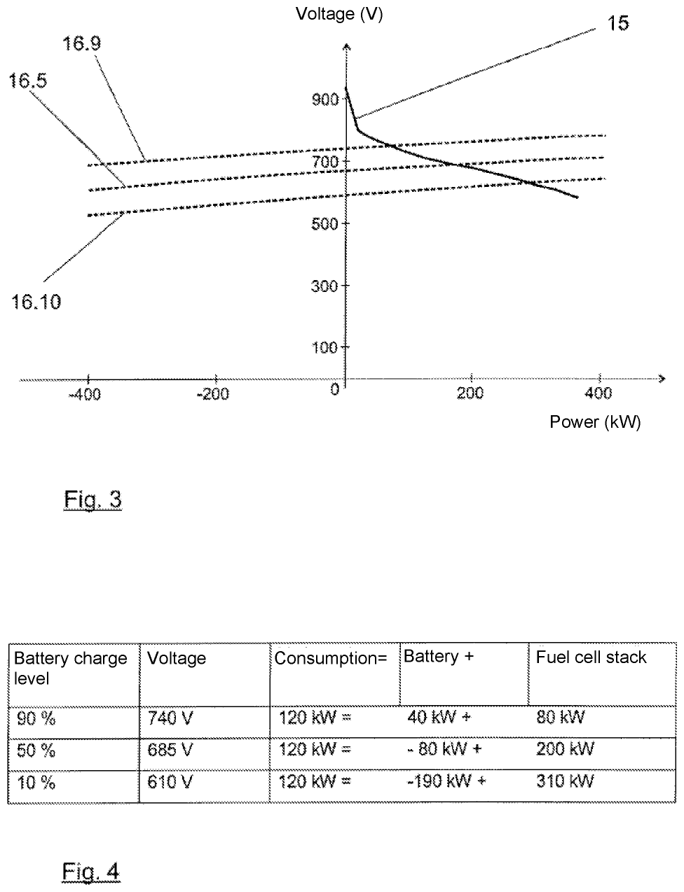

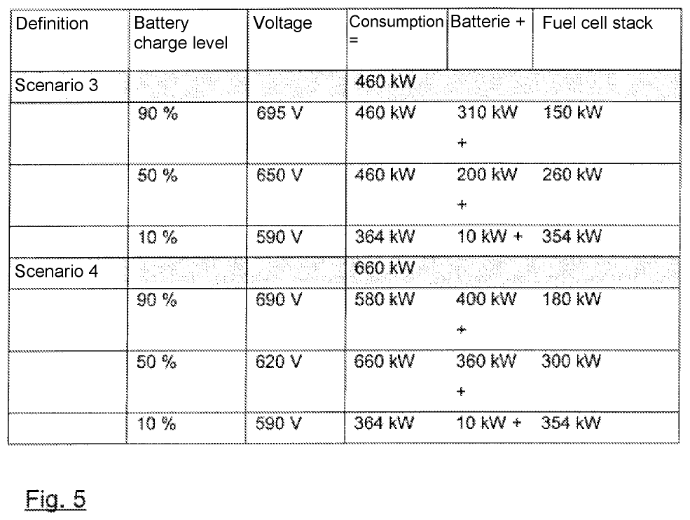

FIG. 4 shows a tabular representation of a first scenario; and

FIG. 5 shows a tabular representation of a third and fourth scenario.

A device 1 serves as a fuel cell power interface and is arranged, according to the representation of FIG. 1, between an indicated fuel cell stack 2 and a high-voltage battery designated as 3. In particular, it can be arranged in a housing 4, which is not specifically shown here but is merely indicated, and which is designed to be connected in particular to the fuel cell stack 2. The device 1 as a fuel cell power interface is suitable for truck applications as well as for stationary fuel cell systems. Contrary to the current state of the art, this new concept does not use a DC/DC converter (step-up converter) to transform the voltage between the fuel cell stack 2 and the high-voltage battery 3.

The device 1, as a cost-effective and space-saving fuel cell power interface, can still efficiently connect the fuel cell stack 2 to the high-voltage battery 3 in order to charge it or to supply the appliance with power, which is shown here as consumer or main consumer 5. The fuel cell power interface according to FIG. 1 consists of a switch 6, in particular a battery safety switch, which is formed from contactors in order to switch the two poles of the connection between the fuel cell stack 2 and the high-voltage battery 3. It also consists of at least one diode 7 and connections 14 for an external power supply of auxiliary units. These are protected by unspecified fuses in the device 1. In addition, two interfaces 8, 9 are provided for external communication. In addition, there are devices 10, 11 for detecting the voltage on the side of the fuel cell stack 2 and the high-voltage battery 3, respectively, as well as an ammeter 12.

For mobile applications, the device 1 additionally contains a pyrotechnic closing device as an emergency shutdown device 13. The pyrotechnic closing device is required to short-circuit the circuit for the fuel cell stack 2 if the high-voltage battery 3 has to be separated from the fuel cell stack 2 in the event of an accident. The emergency shutdown device 13 is connected to one of the external communication interfaces 9 and can be controlled via this, for example when a signal to trigger an airbag occurs.

The switch 6 is designed in the form of two synchronously switching switches or contactors for one and the other of the poles, respectively. However, these are referred to as “one” switch 6 below, but are both referred to. The switch 6 is required to switch on the high-voltage battery 3 when starting the fuel cell stack 2. The diode 7 ensures that no current flows back into the fuel cell stack 2 in order to protect the fuel cell stack 2.

The switch 6 is closed as long as the voltage on the side of the fuel cell stack 2 is lower than on the side of the high-voltage battery 3. The diode 7 protects the fuel cell stack 2 from a negative current. Only when the voltage on the side of the fuel cell stack 2 is increased does a current flow to the high-voltage battery 3 or to the consumer 5. Precharging of the HV intermediate circuit can be eliminated by protecting the fuel cell stack 2 by the diode 7.

The connection of the fuel cell stack 2 with the high-voltage battery 3 through the fuel cell power interface of the device 1 results in a self-regulated fuel cell system. The self-regulation of the fuel cell system with the consumer is shown in the following using the example of a truck application.

This assumes a high-voltage battery 3 with a short-term maximum output of 400 KW and a constant internal resistance of 80 mOhm. The assumed drive unit includes two drives, each with 230 KW continuous power (total 460 KW) and 330 kW peak power (total 660 KW). The fuel cell stack 2 is assumed to be formed by two fuel cell stacks connected in series, each with 245 individual fuel cells. Four different scenarios will be considered below.

The first scenario describes a truck powered by the fuel cell system at a constant speed of 80-100 km/h. For this, the truck needs one of its drive units with a drive power of approx. 120 KW. The current flows i are shown in a very simplified manner in FIG. 2 for better understanding. The current i₂ symbolizes the current from the fuel cell stack 2, the current is the current from or i the high-voltage battery 3, depending on whether charging or discharging is taking place, and the current is the current to the consumer 5. The indicated circles V the corresponding voltages. FIG. 3 shows the profile of the pole curve of the assumed structure with the two fuel cell stacks 2 connected in series. The pole curve is designated 15. In addition, three simplified characteristic curves 16 of the high-voltage battery 3 are shown with different charging states. The battery characteristic curve indicated as 16.1 is for a charge level of 10%, the one with the designation 16.5 for a charge level of 50%, and the one with the designation 16.9 for a charge level of 90%. The characteristic curves 16 are shown in such a way that the high-voltage battery 3 is charged on the right side of the diagram and delivers power to the consumer 5 on the left side of the diagram. In order to deliver the corresponding power of 120 KW to the drive, the following states are entered according to FIG. 3.

When the charge level of the high-voltage battery 3 is 90%, a voltage of 740 V sets in. The power of 120 KW used by the consumer results from 40 KW supplied by the high-voltage battery 3 and 80 KW supplied by the fuel cell stack 2. This is shown in the table in FIG. 4. When the charge level of the high-voltage battery 3 is 50%, the voltage is 685 V. Here, the high-voltage battery 3 is charged with 80 KW, which means that the fuel cell stack 2 generates 200 kW. At a charge level of 10%, the voltage is 610 V. The charging power on the high-voltage battery corresponds in particular to 190 KW. The charging of the high-voltage battery 3 is thus regulated automatically. If the high-voltage battery 3 has a low charging power, it is supplied with high power by the fuel cell stack 2. If the charge level of the high-voltage battery 3 increases, the fuel cell stack 2 reduces its generation power. By reducing the power of the fuel cell stack 2, its efficiency and ultimately its service life also increase. The table in FIG. 4 clearly shows these three states.

In the second scenario, the truck is stopped. The drive therefore does not consume any energy, so that the entire energy of the fuel cell stack 2 can be used to charge the high-voltage battery 3. In the diagram in FIG. 3 we are to the right of the zero line. A tabular presentation was omitted in this case. At a charge level of 90%, a voltage of approximately 750 V sets in, whereby the high-voltage battery 3 is charged with approximately 70 KW. If the high-voltage battery 3 has a charge level of 50%, a voltage of 690 V sets in and the high-voltage battery 3 is charged with 180 KW. At a significantly lower charge level of 10%, a voltage of approx. 620 V sets in and the high-voltage battery 3 is charged with 280 kW.

A third scenario is to be described for 460 KW consumption at continuous drive power and a fourth scenario with 660 KW at drive peak power. Both scenarios 3 and 4 are summarized in the table in FIG. 5.

It is noticeable that in scenario 3 only when the charge level of the high-voltage battery 3 is low, here in particular 10% charge level, the continuous power is not fully available. Scenario 4 shows that the maximum power of 660 kW can only be accessed when the high-voltage battery 3 has a charge level of 50%. On the other hand, a charge level of the high-voltage battery 3 that is too high or too low limits the maximum performance of the fuel cell system.

What is claimed is:

1. A device for electrically connecting at least one fuel cell stack and at least one high-voltage battery for supplying electrical energy to consumers which are connected on the side of the high-voltage battery,
wherein
the fuel cell stack and the high-voltage battery are connected to one other via at least one diode which blocks current flow in the direction of the fuel cell stack and at least one switch for closing and breaking the connection, and
the connection is carried out without a converter.

2. (canceled)

3. The device according to claim 1,
wherein
an emergency shutdown device is provided for the at least one fuel cell stack.

4. The device according to claim 3,
wherein
the emergency shutdown device comprises a pyrotechnic closer and is connected to an external communication interface.

5. The device according to claim 1,
wherein
a control of the switch is connected to an external communication interface,
wherein the switch is formed in particular as a line switch or contactor for both poles of the connection.

6. The device according to claim 1,
wherein
devices for detecting the voltage of the fuel cell stack and the high-voltage battery are provided.

7. The device according to claim 5,
wherein
the control of the switch or an external control connected to the communication interface is configured to actuate the switch depending on voltages detected via the devices for detecting the voltage of the fuel cell stack and the high-voltage battery.

8. The device according to claim 1,
wherein
at least one electrical connection secured by at least one fuse is provided for auxiliary units of the fuel cell system between the diode and the high-voltage battery,
wherein consumers are connected via battery connections of the device.

9. A method for operating a device according to claim 1,
wherein
the switch is controlled depending on the voltages of the at least one fuel cell stack on the one hand and the at least one high-voltage battery on the other hand.

10. The method according to claim 9,
characterized in that the switch is closed before the voltage of the fuel cell stack reaches the voltage of the high-voltage battery.

11. The device according to claim 2,
wherein an emergency shutdown device is provided for the at least one fuel cell stack.

12. The device according to claim 2,
wherein devices for detecting the voltage of the fuel cell stack and the high-voltage battery are provided.

13. The device according to claim 3,
wherein devices for detecting the voltage of the fuel cell stack and the high-voltage battery are provided.

14. The device according to claim 4,
wherein devices for detecting the voltage of the fuel cell stack and the high-voltage battery are provided.

15. The device according to claim 5,
wherein devices for detecting the voltage of the fuel cell stack and the high-voltage battery are provided.

16. The device according to claim 6,
wherein the control of the switch or an external control connected to the communication interface is configured to actuate the switch depending on voltages detected via the devices for detecting the voltage of the fuel cell stack and the high-voltage battery.

17. The device according to claim 2,
wherein at least one electrical connection secured by at least one fuse is provided for auxiliary units of the fuel cell system between the diode and the high-voltage battery, wherein consumers are connected via battery connections of the device.

18. The device according to claim 3,
wherein at least one electrical connection secured by at least one fuse is provided for auxiliary units of the fuel cell system between the diode and the high-voltage battery, wherein consumers are connected via battery connections of the device.

19. The device according to claim 4,
wherein at least one electrical connection secured by at least one fuse is provided for auxiliary units of the fuel cell system between the diode and the high-voltage battery, wherein consumers are connected via battery connections of the device.

20. The device according to claim 5,
wherein at least one electrical connection secured by at least one fuse is provided for auxiliary units of the fuel cell system between the diode and the high-voltage battery, wherein consumers are connected via battery connections of the device.

21. A method for operating a device according to claim 2,
wherein the switch is controlled depending on the voltages of the at least one fuel cell stack on the one hand and the at least one high-voltage battery on the other hand.
